(19) United States
(12) Patent Application Publication
(10) Pub. No.: US 2009/0059015 A1
(43) Pub. Date: Mar. 5, 2009

(54) INFORMATION PROCESSING DEVICE AND REMOTE COMMUNICATING SYSTEM

(75) Inventors: Takeshi CHIBA, Kanagawa (JP); Jun Shingu, Kanagawa (JP); Kei Tanaka, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/048,325

(22) Filed: Mar. 14, 2008

(30) Foreign Application Priority Data
Aug. 30, 2007 (JP) 2007-224349

(51) Int. Cl. H04N 5/225

(52) U.S. Cl. 348/207.11; 348/207.1; 348/E05.024

(57) ABSTRACT

An information processing device is connected to an overview image capturing device that captures an overview image of an object and an enlarged image capturing device that captures an enlarged image of the object, and is connected to a remote control device that remote-controls at least the enlarged image capturing device. The information processing device includes: an encoding unit that encodes the overview image and the enlarged image; a transmitting unit that transmits the images encoded by the encoding unit to the remote control device; and a switching unit that switches an encoding method to be utilized by the encoding unit and a transmission method to be utilized by the transmitting unit among a first mode, a second mode, and a third mode. When there is not a continuous change in the overview image captured by the overview image capturing device, the overview image is transmitted in the first mode. When there is a continuous change in the overview image, the overview image is transmitted in the second mode. The enlarged image captured by the enlarged image capturing device is transmitted in the third mode.

### CROSS-REFERENCE TO RELATED APPLICATION

This application is based on and claims priority under 35 USC 119 from Japanese Patent Application No. 2007-224349 filed Aug. 30, 2007.

### BACKGROUND

1. Technical Field

The present invention relates to an information processing device and a remote communicating system, and more particularly, to an information processing device that is connected to an overview image capturing device that captures an overview image of an object and an enlarged image capturing device that captures an enlarged image of the object, and is also connected to a remote control device that remote-controls at least the enlarged image capturing device, and a remote communicating system that includes the information processing device.

2. Related Art

There has been known a remote diagnosis system that includes a server (a computer, for example) connected to a video camera and a projector, and a client (a computer, for example) located at a remote location and connected to the server via a network. The remote diagnosis system diagnoses a diagnosis object existing on the server side, with the diagnosis being made on the client side.

### SUMMARY

According to an aspect of the invention, there is provided an information processing device that is connected to an overview image capturing device that captures an overview image of an object and an enlarged image capturing device that captures an enlarged image of the object, and is connected to a remote control device that remote-controls at least the enlarged image capturing device. This information processing device includes: an encoding unit that encodes the overview image and the enlarged image; a transmitting unit that transmits the images encoded by the encoding unit to the remote control device; and a switching unit that switches an encoding method to be utilized by the encoding unit and a transmission method to be utilized by the transmitting unit among a first mode, a second mode, and a third mode. When there is not a continuous change in the overview image captured by the overview image capturing device, the overview image is transmitted in the first mode. When there is a continuous change in the overview image, the overview image is transmitted in the second mode. The enlarged image captured by the enlarged image capturing device is transmitted in the third mode.

### BRIEF DESCRIPTION OF THE DRAWINGS

An exemplary embodiment of the present invention will be described in detail based on the following figures, wherein:

FIG. 1 schematically shows the structure of a remote diagnosis system in accordance with an exemplary embodiment of the present invention;

FIGS. 2A and 2B are block diagrams showing the functional structures of the server and each client;

FIG. 3A is a block diagram showing the structure of the image processor of FIG. 2A;

FIG. 3B shows the matrix to be used for selecting an encoding method;

FIG. 4 is a block diagram showing the structure of the communication controller of FIG. 2A;

FIG. 5 is a flowchart showing an operation to be performed by the server to transmit an overview image;

FIG. 6 is a flowchart showing an operation to be performed by the server to transmit an enlarged image;

FIG. 7 shows specific encoding methods and transmission methods in first through third modes;

FIG. 8 is a flowchart showing an operation to be performed by the server in accordance with a modification; and

FIGS. 9A and 9B show a specific example of an operation to be performed by the server in accordance with the modification.

### DETAILED DESCRIPTION

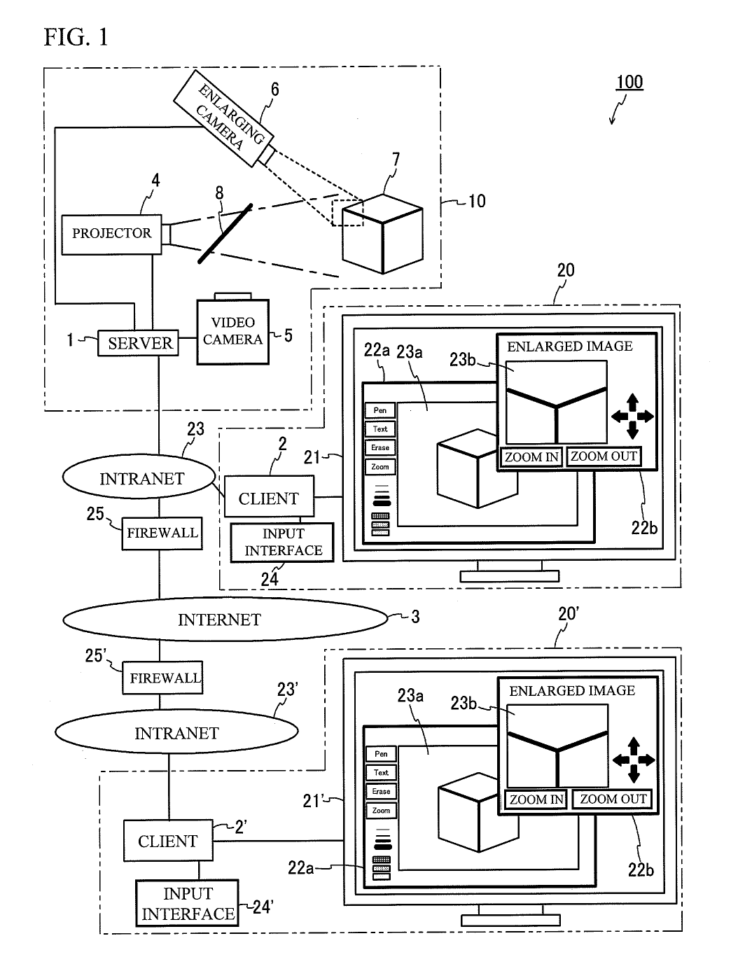

Referring to FIGS. 1 through 7, an exemplary embodiment of the present invention is described in detail.

FIG. 1 schematically shows the structure of a remote diagnosis system 100 that is an exemplary remote communicating system.

The remote diagnosis system 100 of FIG. 1 includes a server system 10 having a personal computer (PC) 1 (an information processing device) functioning as a server, a client system 20 having a PC 2 (a remote control device) functioning as a client, and a client system 20′ having a PC 2′ (a remote control device). Hereinafter, the PC 1 will be referred to as “server 1”, and the PC 2 and the PC 2′ will be referred to as “client 2” and “client 2′”, for ease of explanation.

The server 1 and the client 2 are connected to an intranet 23. The client 2′ is connected to an intranet 23′. The intranet 23 is connected to the Internet 3 via a firewall 25, and the intranet 23′ is connected to the Internet 3 via a firewall 25′.

A projector 4 (a projecting device), a video camera 5 (an overview image capturing device), and an enlarging camera 6 (an enlarged image capturing device) are connected to the server 1.

Based on a control command from the server 1, the projector 4 emits light beams or projects an annotation image or the like onto a diagnosis object 7 through a half mirror 8. An annotation image is an image of any types, including a line, a character, a symbol, a figure, a color, and a font.

The video camera 5 captures a reflected image of the diagnosis object 7 through the half mirror 8, and outputs the captured image (an overview image) to the server 1. The enlarging camera 6 is a video camera having the panning/tilting/zooming function that can capture an enlarged partial image of the diagnosis object 7, and outputs the captured image (an enlarged image) to the server 1.

A display 21 and an input interface 24 such as a mouse are connected to the client 2. The display 21 displays an overview image and an enlarged image in windows 22a and 22b that are separate from each other. A display 21′ and an input interface 24′ are connected to the client 2′. The display 21′ displays the overview image and the enlarged image, which are the same as the images displayed on the display 21, in windows 22a and 22b that are separate from each other. The client 2 (2′) may be formed with a personal computer integrated with the display 21 (21′).

Buttons such as a pen button, a text button, an erase button, and a zoom button, and icons representing line types and color types are displayed in each of the windows 22a. An image captured by the video camera 5 (an overview image) is displayed in a display area 23a in the window 22a. In FIG. 1, the image of the diagnosis object 7 captured by the video camera 5 (an overview image) is displayed in the display area 23a in the window 22a.

In each window 22a with the above arrangement, the pen button is clicked with the input interface 24 (or 24′) connected to the client 2 (or 2′), so as to draw a figure or the like on the diagnosis object 7 through the movement of the mouse pointer. The information about the figure (or more accurately, the coordinates (x, y) representing the figure in the display area 23a) is then output from the client 2 to the server 1. The server 1 converts the information about the figure into the information about the coordinates in the projector 4, and outputs the converted information to the projector 4. Based on the converted information about the figure, the projector 4 projects the figure onto the diagnosis object 7. Since the captured image is displayed in the display area 23a, the coordinates (x, y) in the captured image match the coordinates (x, y) in the display area 23a.

In each window 22a, the zoom button is clicked with the input interface 24 (24′) connected to the client 2 (2′), so as to designate a part of the diagnosis object 7 (for example, the part surrounded by the dotted lines in FIG. 1) with the mouse pointer. The information about the operation is then transmitted from the client 2 to the server 1 via the network (3, 23, or 23′). The server 1 controls the enlarging camera 6 to capture an image of the designated part. The captured image (the enlarged image) is then transmitted from the server 1 to the client 2. The client 2 displays the enlarged image in a display area 23b in the window 22b on the display 21. In each window 22b, a zoom-in button, a zoom-out button, and up and down image moving buttons are shown as well as the display area 23b.

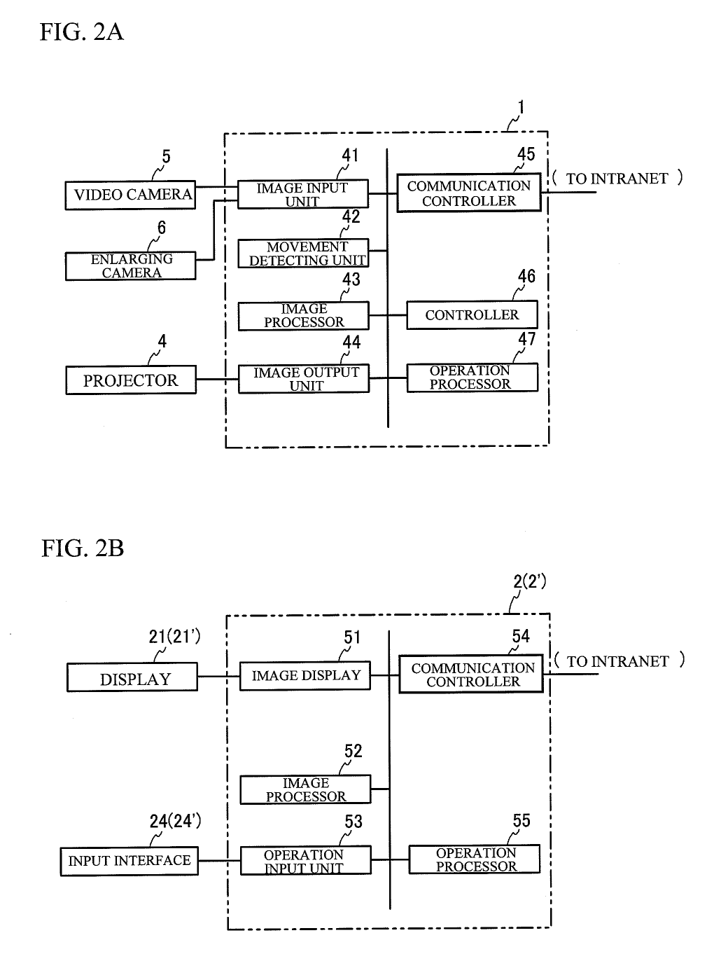

Referring now to FIG. 2A, the functional structure of the server 1 is described. As shown in FIG. 2A, the server 1 includes an image input unit 41, a movement detecting unit 42, an image processor 43, an image output unit 44, a communication controller 45, a controller 46, and an operation performing unit 47.

The image input unit 41 converts image signals that are input from the video camera 5 and the enlarging camera 6 into digital data. The movement detecting unit 42 determines whether there is a continuous change (movement) in an image that is input through the image input unit 41, and notifies the controller 46 of the determination result.

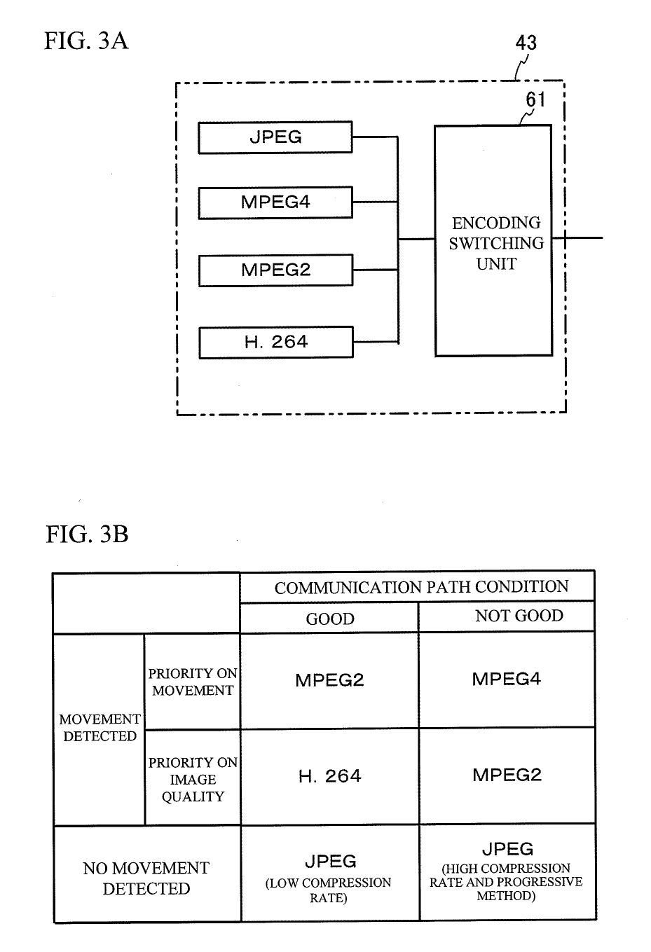

Under the control of the controller 46, the image processor 43 processes (compresses) an image that is input through the image input unit 41. More specifically, the image processor 43 has an encoding switching unit 61, as shown in FIG. 3A. Under the control of the controller 46, the encoding switching unit 61 selects an image compression method from JPEG (with a low compression rate), JPEG (progressive, with a high compression rate), MPEG2, MPEG4, and H.264, for example, and performs an image compressing operation. JPEG is a still image encoding algorithm, and has a compression rate that can be changed by adjusting the encoding parameters. Accordingly, a high compression rate or a low compression rate may be set when appropriate. MPEG2, MPEG4, and H.264 are moving picture encoding algorithms. MPEG2 is characterized by transmission with relatively high image quality. MPEG4 is characterized by transmission at a low transmission rate. H.264 is characterized by transmission with high image quality. The controller 46 switches image compression methods, based on the matrix shown in FIG. 3B, for example (this will be described later in greater detail).

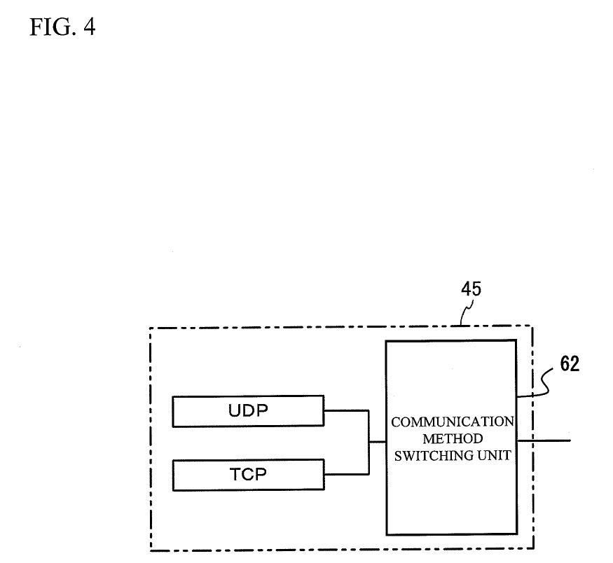

Referring back to FIG. 2A, the image output unit 44 controls the projector 4 to draw an annotation (a figure) or the like on the diagnosis object 7, in accordance with an instruction from the operation performing unit 47. The communication controller 45 transmits image data that is processed by the image processor 43, and controls transmission of camera operation information between the clients 2 and 2′. More specifically, the communication controller 45 includes a communication method switching unit 62, as shown in FIG. 4. The communication method switching unit 62 selects a transmission method (a transmission protocol) from UDP (User Datagram Protocol) and TCP (Transmission Control Protocol), under the control of the controller 46, and transmits image data.

Referring back to FIG. 2A, the controller 46 controls the image processor 43 and the communication controller 45, in accordance with signals from the movement detecting unit 42 and the operation performing unit 47. The operation performing unit 47 receives an instruction from the user of the client 2 (2′) through the communication controller 45, and an instruction from a user existing in the vicinity of the server 1. The operation performing unit 47 notifies the image processor 43, the communication controller 45, and the controller 46 of the operation instructions.

Referring now to FIG. 2B, the functional structure of the client 2 (2′) is described. As shown in FIG. 2B, the client 2 (2′) includes an image display 51, an image processor 52, an operation input unit 53, a communication controller 54, and an operation performing unit 55.

The image display 51 displays an image that is transmitted from the server 1 on the display 21 (21′). The image processor 52 processes the image transmitted from the server 1 into display image data, in accordance with an encoding method and a transmission method (a transmission protocol). The operation input unit 53 receives the information about an operation that is input through the input interface 24 (24′) by a user. The operation input unit 53 then notifies the communication controller 54 of the operation information. The communication controller 54 receives the image data that is transmitted from the server 1, and transmits the information about the user operation transmitted from the operation input unit 53 to the server 1 (to the operation performing unit 47 shown in FIG. 2A). The operation performing unit 55 processes the operation information received through the operation input unit 53, and outputs the operation information to the communication controller 54.

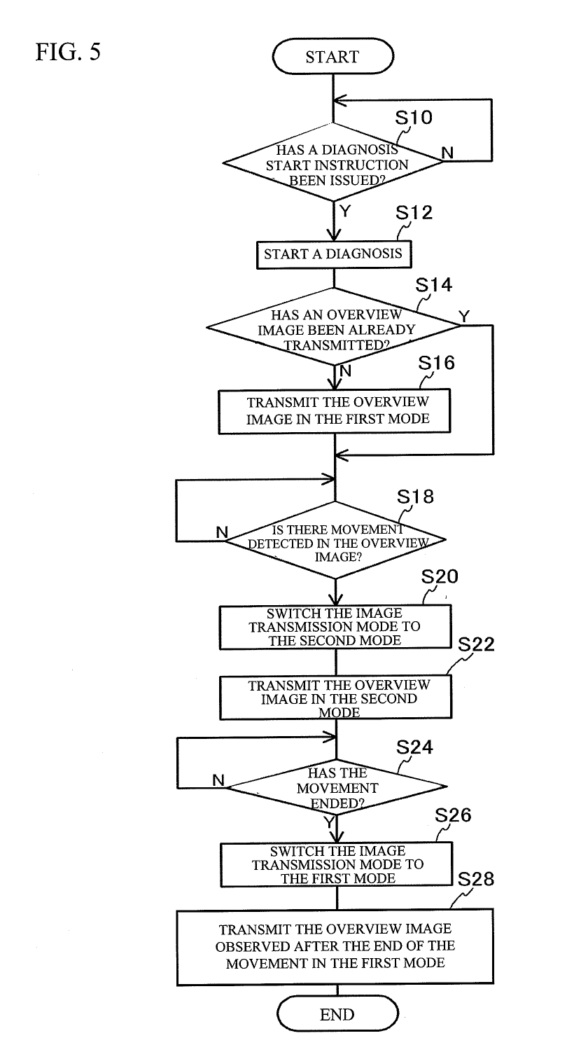

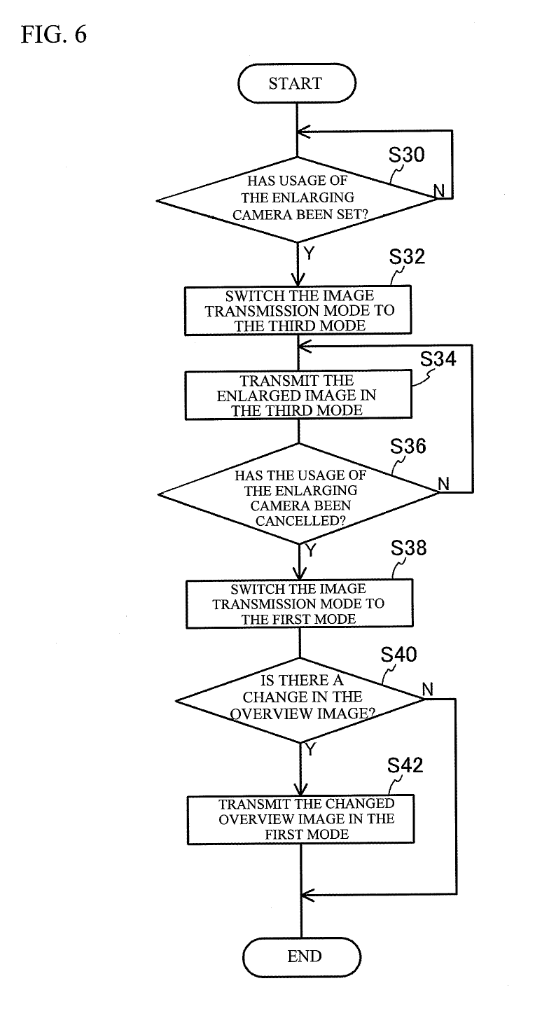

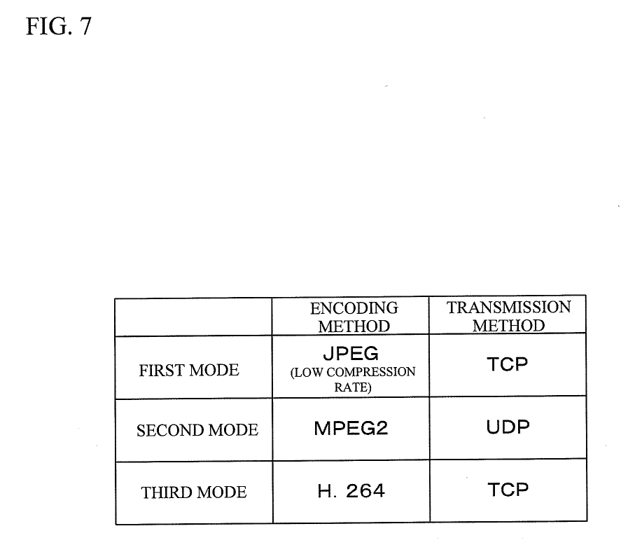

Referring now to FIGS. 5 and 6, operations to be performed in the remote diagnosis system 100 of this exemplary embodiment are described. When this operation is performed, the communication path should be in a “preferred” state. In this exemplary embodiment, to transmit a still overview image, JPEG (with a low compression rate) is selected as the compression method, and TCP is selected as the transmission method (transmission protocol), as shown in the matrix of FIG. 3B. This will be hereinafter referred to as the “first mode”. To transmit a moving overview image, priority is put on the movement (or a decrease in image quality is allowed when the image is moving). Therefore, MPEG2 is selected as the compression method, and UDP is selected as the transmission method (transmission protocol), as shown in the matrix of FIG. 3B. This will be hereinafter referred to as the “second mode”. To transmit an enlarged image, priority is put on the image quality (or a high-quality image should be transmitted even when the image is moving). Therefore, H.264 is selected as the compression method, and TCP is selected as the transmission method (transmission protocol), as shown in the matrix of FIG. 3B. This will be hereinafter referred to as the “third mode”. FIG. 7 is a table showing the specifics of those “modes”.

Referring first to the flowchart of FIG. 5, an operation to be performed by the server 1 to transmit an overview image is described.

In step S10 of FIG. 5, a user places the diagnosis object 7 on a diagnosis table (not shown), and presses the diagnosis start button or the like with the use of the input interface 24 (24′), so as to issue a diagnosis start instruction. The controller 46 of the server 1 then determines whether the operation performing unit 47 has received the diagnosis start instruction. If the determination result is positive, the operation moves on to step S12, so as to start a remote diagnosis. The operation then moves on to step S14, and the controller 46 determines whether an overview image captured by the video camera 5 has already been sent from the communication controller 45 to the client 2 or 2′.

If the determination result of step S14 is negative, the operation moves on to step S16, and the controller 46 sets the image transmission mode to the “first mode” (selecting JPEG (with a low compression rate) as the compression method of the image processor 43, and selecting TCP as the communication protocol of the communication controller 45). The communication controller 45 then transmits the image data compressed by JPEG (with a low compression rate) to the client 2 or 2′ by TCP, and the operation moves on to step S18. Upon receipt of the image data through the communication controller 54, the client 2 or 2′ sends the image data to the image processor 52. The image data is decoded by the image processor 52, and is then sent to the image display 51. The image display 51 displays the decoded overview image in the display area 23a in the window 22a of the display 21 (21′).

If the determination result of step S14 is positive (or in a case where overview image (data) has already been sent), step S16 is skipped, and the operation moves on to step S18.

In step S18, the movement detecting unit 42 determines whether the overview image has movement. When the overview image has movement (when there is a continuous change in a predetermined number of more of pixels, for example), the determination's result of step S18 becomes positive, and the operation moves on to step S20. In step S20, the image transmission mode is changed to the “second mode” (switching the compression method of the image processor 43 to MPEG2, and switching the communication protocol of the communication controller 45 to UDP).

In step S22, the communication controller 45 transmits the image data obtained by the image processor 43 compressing the overview image by MPEG2, to the client 2 or 2′ by UDP. After that, image data transmission is continued (step S24) until the movement ends. When the movement ends, the operation moves on to step S26. Upon receipt of the image data through the communication controller 54, the client 2 or 2′ sends the overview image data to the image processor 52. The image data is decoded by the image processor 52, and is sent to the image display 51. The image display 51 displays the decoded overview image (a moving image) in the display area 23a in the window 22a of the display 21 (21′).

In step S26, the image transmission mode is changed back to the first mode (JPEG (with a low compression rate) and TCP), and the operation moves on to step S28. In step S28, the overview image observed when the movement ends (the image data processed by the image processor 43) is transmitted to the client 2 or 2′ through the communication controller 45 in the first mode, and the operation shown in FIG. 5 is completed. Upon receipt of the image data through the communication controller 54, the client 2 or 2′ sends the overview image data to the image processor 52. The image data is decoded by the image processor 52, and is sent to the image display 51. The image display 51 displays the decoded overview image in the display area 23a in the window 22a of the display 21 (21′).

Referring now to the flowchart of FIG. 6, an operation to be performed by the server 1 to transmit an enlarged image is described.

In step S30 of FIG. 6, when the user of the client 2 (2′) presses the enlarging camera use button with the use of the input interface 24 (24′), the controller 46 determines whether usage of the enlarging camera 6 is set. If the determination result is positive, the operation moves on to step S32. In step S32, the controller 46 changes the image transmission mode to the “third mode” (switching the compression method of the image processor 43 to H.264, and switching the communication protocol of the communication controller 45 to TCP).

In step S34, the communication controller 45 transmits the image data obtained by the image processor 43 compressing an enlarged image by H.264 to the communication controller 54 of the client 2 or 2′. Upon receipt of the enlarged image data through the communication controller 54, the client 2 or 2′ sends the enlarged image data to the image processor 52. The image data is decoded by the image processor 52, and is sent to the image display 51. The image display 51 displays the decoded enlarged image in the display area 23a in the window 22a of the display 21 (21′).

In step S36, when the user of the client 2 (2′) presses the use end button for the enlarging camera 6 with the use of the input interface 24 (24′), the controller 46 determines whether the usage of the enlarging camera 6 has been cancelled. The communication controller 45 continues enlarged image data transmission until the determination result of step S36 becomes positive. When the determination result becomes positive, the communication controller 45 stops the enlarged image data transmission, and the operation moves on to step S38. In step S38, the image transmission mode is changed to the “first mode”.

In step S40, whether there is a change in an overview image is determined while the enlarging camera 6 is being used. If the determination result is positive, the overview image (overview image data) is transmitted in the first mode to the client 2 or 2′ in step S42, and the operation (processing and determinations) according to the flowchart of FIG. 6 is completed. Upon receipt of the image data through the communication controller 54, the client 2 or 2′ sends the overview image data to the image processor 52. The image data is decoded by the image processor 52, and is sent to the image display 51. The image display 51 displays the decoded overview image in the display area 23a in the window 22a of the display 21 (21′).

If the determination result of step S40 is negative, step S42 is skipped, and the operation shown in FIG. 6 is ended.

As described so far in detail, in the remote diagnosis system of this exemplary embodiment, image transmission is performed by an encoding method and a transmission method that are selected from the first mode in which an overview image is transmitted when the overview image does not have movement (a continuous change), the second mode in which an overview image is transmitted when the overview image has movement, and the third mode in which an enlarged image captured by the enlarging camera 6 is transmitted. In this manner, an encoding method and a transmission method that are suitable for each image can be selected, and image transmission can be performed in accordance with the needs of the user and the communication speed between the server and the client. Especially, in a case where an overview image has movement, there is a high probability that the diagnosis object 7 is moving or the video camera 5 is performing a panning/tilting/zooming operation in this exemplary embodiment. In such a case, the overview image is highly likely an image that is important to the user observing overview images. In a case where an overview image does not have movement, on the other hand, the image is highly likely an image that is relatively important to the user observing overview images. With those facts being taken into consideration, a suitable encoding method and transmission method should be selected (MPEG2 and UDP should be selected in the former case, and JPEG (with a low compression rate) and TCP should be selected in the latter case, for example). Thus, appropriate image transmission can be performed.

In this exemplary embodiment, the encoding method of the third mode is an encoding method (H.264) by which an overall image having higher image quality than the image quality achieved by the encoding method (MPEG2) of the second mode can be obtained, and the transmission method (transmission protocol) of the third mode is a transmission method (TCP) with higher reliability than the transmission method (UDP) of the second mode. Accordingly, an enlarged image that is highly likely an important image to the user observing images (the user diagnosing the diagnosis object 7) can be effectively transmitted.

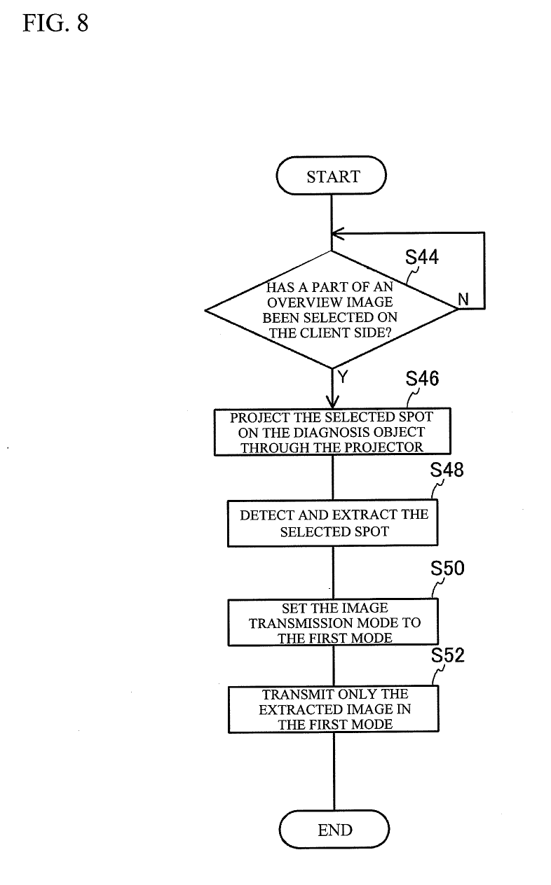

In the above described exemplary embodiment, the operation shown in FIG. 8 may be performed concurrently with the operations shown in FIGS. 5 and 6. The operation shown in FIG. 8 is performed to transmit a partial image selected by the user of the client 2 (2′) from the server 1 to the client 2 or 2′.

More specifically, in the client 2 (2′), the user draws a figure surrounding a part of an overview image with the use of the input interface 24 (24′). When the user issues an instruction to enlarge and transmit the part (the selected spot) surrounded by the figure, the instruction information is transmitted from the communication controller 54 and the operation performing unit 47 of the server 1 through the operation input unit 53 and the operation performing unit 55 of the client 2 (2′). Therefore, in step S44 of FIG. 8, the controller 46 determines whether the instruction information has been sent from the client 2 or 2′. If the determination result is positive, the operation moves on to step S46.

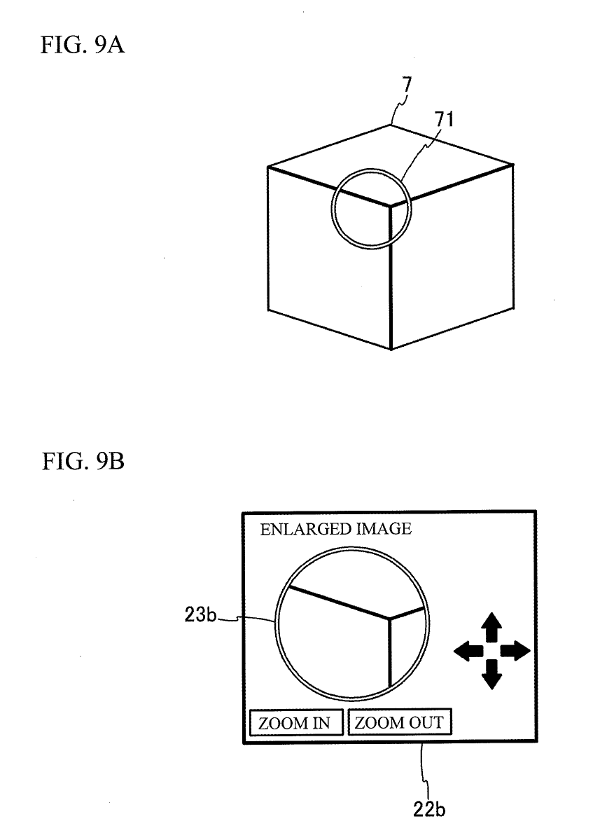

In step S46, based on the instruction information input to the operation performing unit 47, the image output unit 44 projects a figure (corresponding to the selected spot) on the diagnosis object 7 through the projector 4. FIG. 9A shows a specific example of the projected state (the projected figure being denoted by reference numeral “71”).

In step S48, the image processor 43 recognizes and extracts the selected spot from an image that is input to the image input unit 41.

In step S50, the controller 46 sets the image transmission mode to the “first mode”. In step S52, the image processor 43 compresses only the extracted part of the image by the compressing JPEG (with a low compression rate), and the communication controller 45 transmits the compressed data to the client 2 or 2′ by TCP. The entire operation shown in FIG. 8 then comes to an end. When the client 2 or 2′ receives the extracted image data through the communication controller 54, the extracted image data is sent to the image processor 52. The image data is decoded by the image processor 52, and is sent to the image display 51. The image display 51 displays the decoded extracted part of the image in the display area 23b in the window 22b of the display 21 (21′), as shown in FIG. 9B.

In the above described manner, the user can display a part to be specifically observed (the part to be diagnosed) on the display 21 (21′) with high image quality simply by drawing a figure surrounding the part to be observed. In the above described exemplary embodiment, the server 1 transmits only the part surrounded by a figure to the client 2 or 2′. However, the present invention is not limited to that, and it is possible to transmit an entire overview image, with the part surrounded by a figure having high image quality, and the other part having low image quality, for example.

In the above described exemplary embodiment, enlarged image data transmission is always performed in the third mode (H.264 being set as the compression method, TCP being set as the transmission method). However, the present invention is not limited to that, and the server 1 may transmit an enlarged image as a still image to the client 2 or 2′, when the enlarged image does not have movement (where the user of the client 2 or 2′ does not control the enlarging camera 6 to perform a panning/tilting/zooming operation, for example). In such a case, the enlarged image data can be transmitted in the same mode (by the same encoding method and transmission method) as the first mode. Also, when an enlarged image has movement, the enlarged image may be transmitted with low image quality, and an enlarged image may be transmitted only when the enlarged image does not have movement.

In the above described exemplary embodiment, a user may select an encoding method and a transmission method for each mode. Especially, for enlarged image data in the third mode, the function (a setting unit) for setting an encoding method and a transmission method in accordance with the needs of the user (priorities being put on movement or image quality, for example) may be provided in the clients 2 and 2′ and the server 1.

Although not specifically mentioned in the description of the above exemplary embodiment, overview image transmission from the server 1 to the client 2 or 2′ may be stopped (suspended) while a user is using the enlarging camera 6. Alternatively, it is possible to put priority on enlarged image transmission (by degrading the image quality or lowering the communication speed for overview image transmission), though overview image transmission is performed concurrently with the enlarged image transmission.

In the above described exemplary embodiment, the communication path is supposedly in good condition. However, there may be cases where the condition of the communication path is not good. In such cases, the compression methods shown in the right-side column of the table shown in FIG. 3B can be selected. For example, in a case where a still overview image is transmitted while the condition of the communication path is not good, an encoding method and a transmission method should be selected so that an entire image can be formed. More specifically, the data for image transmission with low image quality is preferentially transmitted, and, if there is not a problem with the transmission method, image data for transmitting an image with higher image quality is transmitted. This is a so-called progressive encoding method.

In a case where an overview image does not have movement in the above described exemplary embodiment, the overview image is not transmitted before a change is caused in the overview image (see step S16 and step S28 of FIG. 5). However, the present invention is not limited to that, and an overview image may be constantly transmitted to the client 2 or 2′, even if there is not a change in the overview image.

In the above described exemplary embodiment, movement is detected from an entire overview image, and a transmission method is set in accordance with whether there is movement. However, the present invention is not limited to that. For example, an overview image may be divided into smaller areas, and movement detection is performed for each of the areas. Based on the detection results, an encoding method and a transmission method for each area may be set.

In the above described exemplary embodiment, there are two clients (the clients 2 and 2′). However, the present invention is not limited to that arrangement, and there may be three or more clients. Also, the network structure of the present invention is not limited to the network structure shown in FIG. 1, and it is possible to employ various kinds of structures (for example, a structure having one of the server 1 and the clients 2 and 2′ connected directly to the Internet 3, and a structure having the server 1 and the clients 2 and 2′ connected to the same intranet).

The encoding methods shown in FIGS. 3A and 3B and the transmission methods (transmission protocols) shown in FIG. 4 are mere examples, and it is of course possible to use other encoding methods and transmission methods.

The above described exemplary embodiment is a mere example of an exemplary embodiment of the present invention. However, the present invention is not limited to that, and various changes and modifications may be made to it without departing from the scope of the invention.

What is claimed is:

1. An information processing device that is connected to an overview image capturing device that captures an overview image of an object and an enlarged image capturing device that captures an enlarged image of the object, and is connected to a remote control device that remote-controls at least the enlarged image capturing device,
the information processing device comprising:
an encoding unit that encodes the overview image and the enlarged image;
a transmitting unit that transmits the images encoded by the encoding unit to the remote control device; and
a switching unit that switches an encoding method to be utilized by the encoding unit and a transmission method to be utilized by the transmitting unit among a first mode, a second mode, and a third mode, the overview image being transmitted in the first mode when there is not a continuous change in the overview image captured by the overview image capturing device, the overview image being transmitted in the second mode when there is a continuous change in the overview image, the enlarged image captured by the enlarged image capturing device being transmitted in the third mode.

2. The information processing device according to claim 1, wherein:
the encoding method of the first mode is an encoding method by which the overview image has higher image quality than image quality achieved by the encoding method of the second mode; and
the transmission method of the first mode is a transmission method with higher reliability than the transmission method of the second mode.

3. The information processing device according to claim 1, wherein:
the encoding method of the third mode is an encoding method by which the overview image has higher image quality than image quality achieved by the encoding method of the second mode; and
the transmission method of the third mode is a transmission method with higher reliability than the transmission method of the second mode.

4. The information processing device according to claim 3, wherein the encoding methods of the second mode and the third mode are for encoding moving images.

5. The information processing device according to claim 4, wherein the switching unit sets the same encoding method and transmission method as the encoding method and transmission method of the first mode, when there is not a continuous change in the enlarged image in the third mode.

6. The information processing device according to claim 4, further comprising
a setting unit that sets the encoding method and transmission method of the third mode in accordance with an instruction from a user.

7. The information processing device according to claim 1, wherein the transmitting unit stops transmitting the overview image while transmitting the enlarged image.

8. The information processing device according to claim 1, which is further connected to a projecting device that projects a figure on the object,
the information processing device further comprising
an extracting unit that extracts an image from the projected figure,
wherein the switching unit switches the encoding method and transmission method so that the image extracted by the extracting unit is transmitted to the remote control device in the same encoding method and transmission method as the encoding method and transmission method of the first mode.

9. The information processing device according to claim 1, wherein the overview image is transmitted by a progressive encoding method in the first mode.

10. A remote communicating system comprising:
the information processing device according to claim 1, which is connected to an overview image capturing device that captures an overview image of an object and an enlarged image capturing device that captures an enlarged image of the object; and
a remote control device that remote-controls at least the enlarged image capturing device, and displays an image transmitted from the information processing device.
